(19) United States
(12) Patent Application Publication
(10) Pub. No.: US 2024/0323196 A1
(43) Pub. Date: Sep. 26, 2024

(54) Dynamic Event Parameter Modification Based on Contextual Data

(71) Applicant: Bank of America Corporation, Charlotte, NC (US)

(72) Inventor: Gopalakrishnan Nt, Tamilnadu (IN)

(21) Appl. No.: 18/125,927

(22) Filed: Mar. 24, 2023

(51) Int. Cl. H04L 9/40; G06Q 20/40

(52) U.S. Cl. CPC H04L 63/105; G06Q 20/401

(57) ABSTRACT

Arrangements for product security control are provided. In some aspects, user product data, such as accounts, payment devices, and the like, may be received. The user product data may be aggregated to generate ringfenced user products. As a user anticipates a change in risk of unauthorized access to a product, the user may request to modify a security level associated with the ringfenced user products. For instance, the user may request to modify a first security level to a second security level. In response, if the user is authenticated, the security level of the ringfenced user products may be modified from the first security level to the second security level and one or more parameters associated with each product of the ringfenced products may be modified to apply parameters associated with the second security level.

### BACKGROUND

Aspects of the disclosure relate to electrical computers, systems, and devices for controlling and modifying event or product security parameters based on contextual data.

Consumers today often rely on various products or channels to maintain funds, pay bills, make purchases, and the like. For instance, a user may have a checking account, a savings account, one or more credit cards, and a debit card that they may use for purchases, bill payment, savings, and the like. However, each product or channel may be susceptible to unauthorized use by unauthorized actors. Accordingly, maintaining security associated with each of the various products or channels may be challenging and may require modifying security parameters, such as security controls, for each product or channel individually. It may be advantageous to have a system that uses a ringfence to aggregate products or channels associated with a user and modify, via one system, security controls for all ringfenced products or channels.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with dynamically controlling product or event security parameters.

In some aspects, user product data may be received. For instance, user products associated with an enterprise organization, such as accounts, payment devices, and the like, may be received. In some examples, the product data may be aggregated to generate ringfenced user products. In some arrangements, a user may customize limits or restrictions associated with each product of the ringfenced user products for one or more security levels.

As a user anticipates a change in risk (e.g., increased or decreased risk) of unauthorized access to a product, the user may request to modify a security level associated with the ringfenced user products. For instance, the user may request, via an application executing on a user computing device, to modify a first security level to a second security level. In response, the user may be authenticated and, if authenticated, the security level of the ringfenced user products may be modified from the first security level to the second security level. Accordingly, one or more parameters, such as limits, restrictions, and the like, associated with each product of the ringfenced products may be modified to apply parameters associated with the second security level. When a transaction is requested, it may be compared to the second parameters to determine whether the transaction is approved or denied. The user may then further modify the security level as desired.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing product control functions in accordance with one or more aspects described herein;

FIGS. 2A-2K depict an illustrative event sequence for implementing product security control functions in accordance with one or more aspects described herein;

FIG. 3 depicts an illustrative method for implementing product security control functions in accordance with one or more aspects described herein;

FIGS. 4 and 5 illustrate example user interfaces that may be generated in accordance with one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, users often have a plurality of products that are associated with an enterprise organization, such as a financial institution, that are used to pay bills, make purchases, save for retirement, and the like. If an unauthorized user gains access to one or more products, such as an account, payment device, or the like, the user may be at risk for financial loss. Accordingly, it would be advantageous to have a system for modifying transaction limits on products to reduce risk of loss.

Accordingly, aspects described herein are directed to a system for ringfencing user products or channels to control security associated with each product or channel. In some examples, a computing platform may receive user product data associated with one or more user products or channels, such as bank accounts, credit cards, debit cards, and the like. The user products or channels may be aggregated within a user-specific ringfence that may enable a user to control security parameters for all products or channels within the ringfence.

For instance, a user may have an application executing on a mobile device provided by an enterprise organization associated with all ringfenced products or channels. The user may login to the application using first authentication credentials and may request modification of security controls. In response, the application may request second, different authentication credentials to provide access to security control modification or ringfence aspects.

Upon authenticating the user, the security level and associated parameters for all ringfenced user products may be modified to the requested security level. Accordingly, one or more transaction limits, spending limits, transaction restrictions, or the like, may be modified based on the modified security level. For instance, a user may register with the system and provide inputs for limits on products or channels for various levels of security controls. In one example, for a highest level of security controls, a user may indicate that a withdrawal limit of $50 may be enforced on all accounts and purchases over $100 using a payment device, such as a debit or credit card, may be restricted. For a medium level of security controls, the user may indicate that a withdrawal limit of $250 should be enabled and purchases up to $500 on a payment device may be permitted. In some examples, a lowest level of security may be a default level and may include standard limits (e.g., enterprise organization limits on withdrawals, credit card limits, or the like) or may include user customized limits or controls.

The limits provided above are merely some example limits. Additional or alternative limits or controls may be used without departing from the invention.

The user may, in some examples, select a further modified level of security controls which may then be executed and limits on the products and channels aggregated within the ringfence may be modified.

In some examples, the modified security controls may be based on contextual data. For instance, a user may be traveling and might desire to have heightened security controls in an airport or other setting where, for instance, a credit card may be obtained by an unauthorized user. Accordingly, the user may select a modified level of security controls to reduce risk associated with unauthorized access to one or more products or channels.

These and various other arrangements will be discussed more fully below.

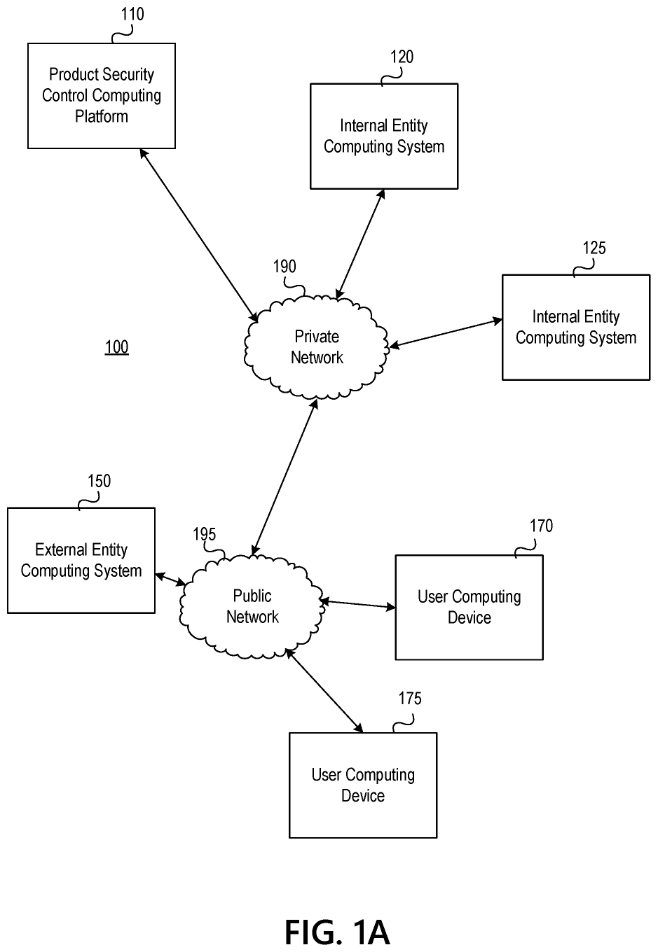

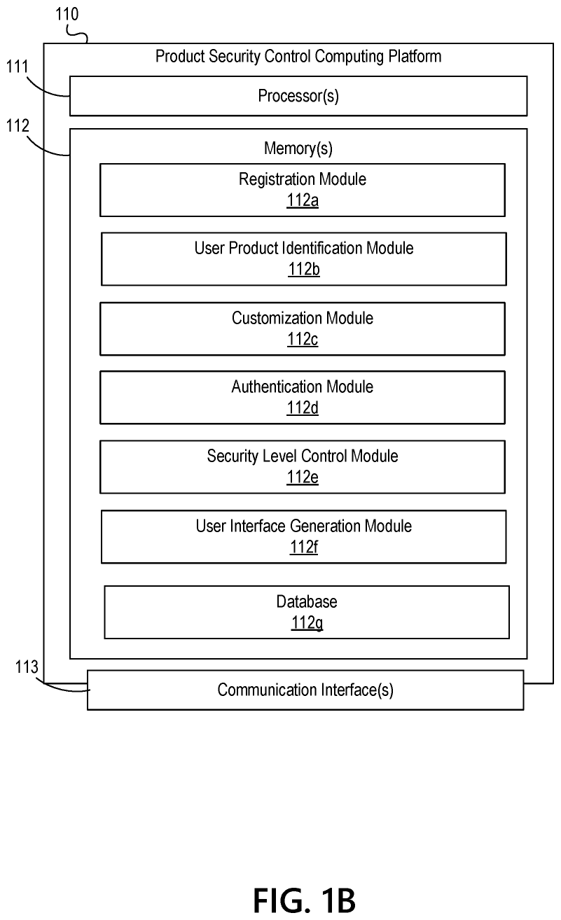

Aspects described herein may be implemented using one or more computing devices operating in a computing environment. For instance, FIGS. 1A-1B depict an illustrative computing environment for implementing a product security control system in accordance with one or more aspects described herein. Referring to FIG. 1A, computing environment 100 may include one or more computing devices and/or other computing systems. For example, computing environment 100 may include product security control computing platform 110, internal entity computing system 120, internal entity computing system 125, external entity computing system 150, user computing device 170 and/or user computing device 175. Although two internal entity computing systems 120, 125, one external entity computing system 150 and two user devices 170, 175 are shown, any number of systems or devices may be used without departing from the invention.

Product security control computing platform 110 may be configured to provide intelligent, dynamic and efficient control of product or event parameters, such as security controls, for a group of aggregated or ringfenced user products or channels. In some examples, product security control computing platform 110 may receive user product or channel data. For instance, product security control computing platform 110 may be implemented by or associated with an enterprise organization, such as a financial institution. The enterprise organization may hold or host a plurality of products or channels for a plurality of users. Accordingly, user product and channel data, such as user accounts (e.g., checking accounts, savings accounts, retirement accounts, and the like), payment devices such as credit cards and debit cards, and the like, may be aggregated for the user. In some examples, default security controls may be implemented which may, e.g., be determined by the user at registration or may be determined by the enterprise organization.

Accordingly, a user may request (e.g., via an application executing on user computing device 170, user computing device 175, or the like and associated with the enterprise organization) to modify event or product parameters, such as security controls. The product security control computing platform 110 may cause a user interface to be displayed by user computing device 170, user computing device 175, or the like, (e.g., upon authentication of the user) and the user may select a modified level of security controls.

The product security control computing platform 110 may receive user input (e.g., via the user interface) identifying a modified level of controls and may execute the modified level of controls for all ringfenced products or channels for that user.

Internal entity computing system 120 and/or internal entity computing system 125 may be or include or more computing devices (e.g., servers, server blades, or the like) and/or one or more computing components (e.g., memory, processor, and the like) and may be configured to host or execute one or more applications or systems supporting user products and/or channels. For instance, internal entity computing system 120 may host or execute one or more applications or systems may be a transaction processing computing system, a system supporting user accounts (e.g., account ledgers, account transaction processing, or the like), one or more payment devices (e.g., user credit cards, debit cards, or the like) and/or may interface with one or more external entity computing systems, such as external entity computing system 150 to perform one or more functions.

External entity computing system 150 may be associated with an entity other than the enterprise organization and may host or execute one or more systems or applications supporting, for instance, transaction processing. For instance, external entity computing system 150 may be associated with a credit card processing agency.

User computing device 170 and/or user computing device 175 may be or include one or more user computing devices, such as mobile devices, laptops, smart phones, tablets, wearable devices, desktop computers, and the like. User computing device 170 and/or user computing device 175 may be configured to execute one or more applications, such as a mobile banking application associated with the enterprise organization, display user interfaces, receive input via user interfaces and/or communicate with one or more other devices or systems, such as product security control computing platform 110.

As mentioned above, computing environment 100 also may include one or more networks, which may interconnect one or more of product security control computing platform 110, internal entity computing system 120, internal entity computing system 125, external entity computing system 150, user computing device 170 and/or user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, product security control computing platform 110, internal entity computing system 120, and/or internal entity computing system 125, may be associated with an enterprise organization (e.g., a financial institution), and private network 190 may be associated with and/or operated by the organization, and may include one or more networks (e.g., LANs, WANs, virtual private networks (VPNs), or the like) that interconnect product security control computing platform 110, internal entity computing system 120, and/or internal entity computing system 125, and one or more other computing devices and/or computer systems that are used by, operated by, and/or otherwise associated with the organization. Public network 195 may connect private network 190 and/or one or more computing devices connected thereto (e.g., product security control computing platform 110, internal entity computing system 120, internal entity computing system 125) with one or more networks and/or computing devices that are not associated with the organization. For example, external entity computing system 150, user computing device 170 and/or user computing device 175 might not be associated with an organization that operates private network 190 (e.g., because external entity computing system 150, user computing device 170 and/or user computing device 175 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 150, user computing device 170 and/or user computing device 175 to private network 190 and/or one or more computing devices connected thereto (e.g., product security control computing platform 110, internal entity computing system 120, internal entity computing system 125).

Referring to FIG. 1B, product security control computing platform 110 may include one or more processors 111, memory 112, and communication interface 113. A data bus may interconnect processor(s) 111, memory 112, and communication interface 113. Communication interface 113 may be a network interface configured to support communication between product security control computing platform 110 and one or more networks (e.g., network 190, network 195, or the like). Memory 112 may include one or more program modules having instructions that when executed by processor(s) 111 cause product security control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of product security control computing platform 110 and/or by different computing devices that may form and/or otherwise make up product security control computing platform 110.

For example, memory 112 may have, store and/or include registration module 112a. Registration module 112a may store instructions and/or data that may cause or enable the product security control computing platform 110 to receive a request to access ringfence functionality, identify new customers or users of the enterprise organization and generate an offer to access ringfence functionality, and the like. In some examples, registration module may generate and transmit, to a user computing device 170 of a user, an option to opt-in to ringfence functionality. Additionally or alternatively, a user may request to opt-in to ringfence functionality. The user may provide, e.g., during a registration process, user identifying information (e.g., name, unique identifier, contact information, and the like).

Product security control computing platform 110 may further have, store and/or include user product identification module 112b. User product identification module 112b may store instructions and/or data that may cause or enable the product security control computing platform 110 to retrieve, from one or more systems of the enterprise organization, such as internal entity computing system 120, internal entity computing system 125, and the like, all products associated with the user. For instance, user product identification module 112b may request, from one or more internal entity computing systems 120, 125, all products or relationships associated with the user or user identifier provided during the registration process. Accordingly, all accounts (e.g., money market accounts, checking accounts, savings accounts, and the like), payment devices (e.g., debit cards, credit cards, and the like), retirement accounts (e.g., mutual funds, annuities, 401k, and the like), insurance policies, and the like, associated with the user or user identifier and held by the enterprise organization may be identified and ringfence enabled such that a modification of security controls may modify security controls for all products associated with the user.

Product security control computing platform 110 may further have, store and/or include customization module 112c. Customization module 112c may store instructions and/or data that may cause or enable the product security control computing platform 110 to transmit, to the user computing device 170, a request for customization of limits on products for each level of security controls associated with the ringfence. For instance, a user may customize limits on each account, payment device, may disable or prevent funds transfer at some levels of security controls, and the like. In some arrangements, the enterprise organization may provide default limits (e.g., based on standard limits for each product) for each level of security. Accordingly, a user may decline to customize limits or may customize limits on some or all of the products for one or more security levels.

Product security control computing platform 110 may further have, store and/or include authentication module 112d. Authentication module 112d may store instructions and/or data that may cause or enable product security control computing platform 110 to request, from a user registering with the system, authentication credentials. In some examples, the authentication credentials must be different from (e.g., may not match) authentication credentials used to access the application through which security levels may be modified. For instance, the authentication credentials used to request modification of a security level on all ringfenced products may be different from the authentication credentials used to access the, for instance, mobile banking application through which the request may be made. Accordingly, in arrangements in which a user has lost their phone, an unauthorized actor may be able to access the mobile banking application but would need separate authentication credentials to modify the security level and/or limits in place for the ringfenced products. This provides additional security and risk mitigation for the user.

Authentication data may include a username and password, personal identification number (PIN), biometric data, and the like. In some examples, a one-time passcode might not be used to authenticate the user to modify security levels in case the user's phone has been lost or is in the hands of unauthorized users who would then be able to access the one-time passcode. In some examples, multiple authentication credentials may be stored by authentication module 112d. For instance, a user requesting to modify a security level for ringfenced products via the application executing on user computing device 170 may input one set of authentication credentials or one form of authentication, while a user requesting to modify a security level via, for instance, a call center (e.g., a telephone or in-person conversation with an associate of the enterprise organization) may provide a passphrase or other authentication data. In some examples, multi-factor authentication may be used when requesting to modify the security level on ringfenced products.

Product security control computing platform 110 may further have, store and/or include security level control module 112e. Security level control module 112e may store instructions and/or data that may cause or enable the product security control computing platform 110 to modify a security level for ringfenced products for a requesting user, generate an instruction or command implementing the modified security level and transmit or send, to, for instance, internal entity computing system 120, internal entity computing system 125, or the like, the generated instruction or command. In some examples, sending the generated instruction or command may cause the internal entity computing system 120, 125 to execute the instruction and modify one or more limits on the ringfenced products (e.g., based on user customization and/or enterprise organization default settings for the modified security level).

Product security control computing platform 110 may further have, store and/or include user interface generation module 112f. User interface generation module 112f may store instructions and/or data that may cause or enable the product security control computing platform 110 to generate one or more user interfaces (e.g., requesting authentication data, providing notification of approval/denial of transactions, providing modified security level information, and the like). The generated user interfaces may be transmitted to, for instance, user computing device 170, user computing device 175, or the like. In some examples, transmitting the generated user interface may cause the user computing device 170, user computing device 175, or the like, to display the user interface on a display of the device.

Product security control computing platform 110 may further have, store and/or include a database 112g. Database 112g may store data associated with customized limits for ringfenced products, historical transaction data for users, historical security level data for users, and the like.

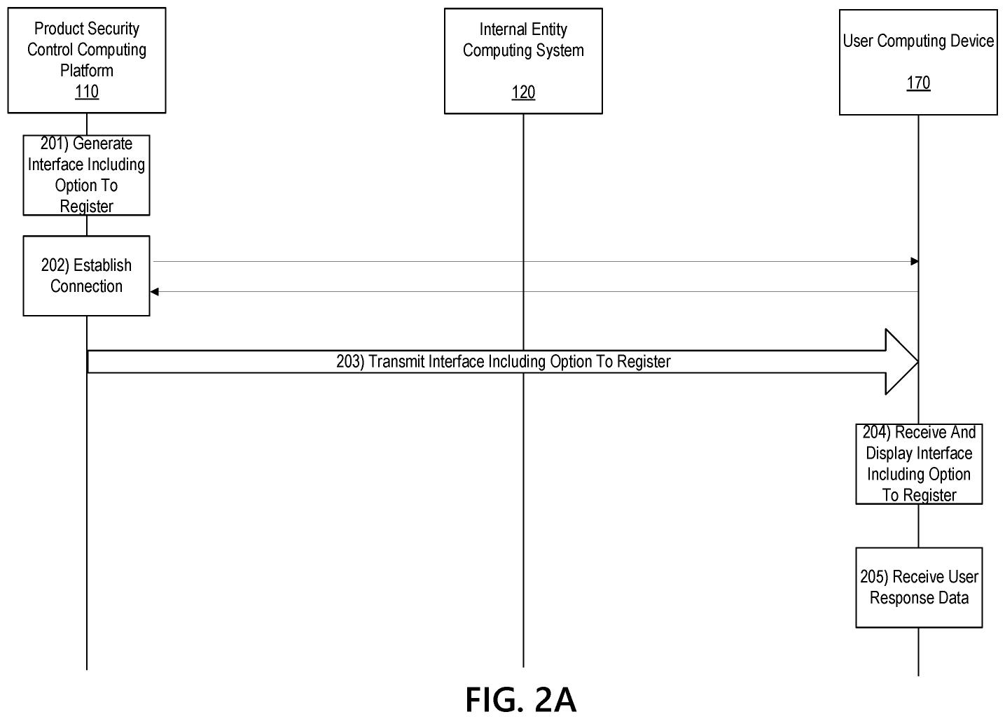

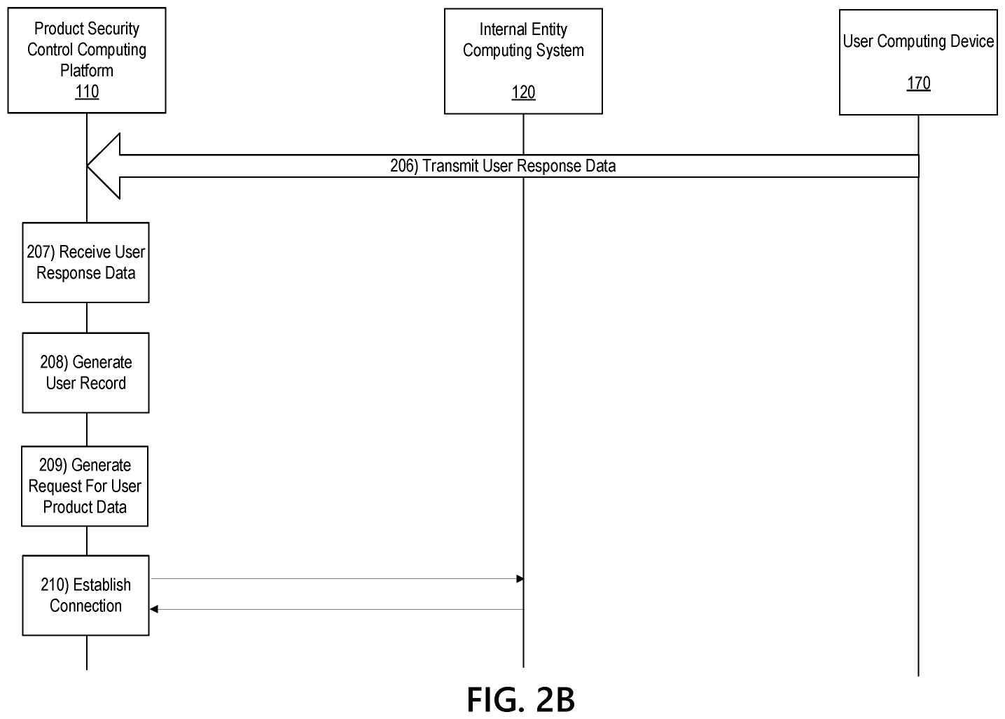

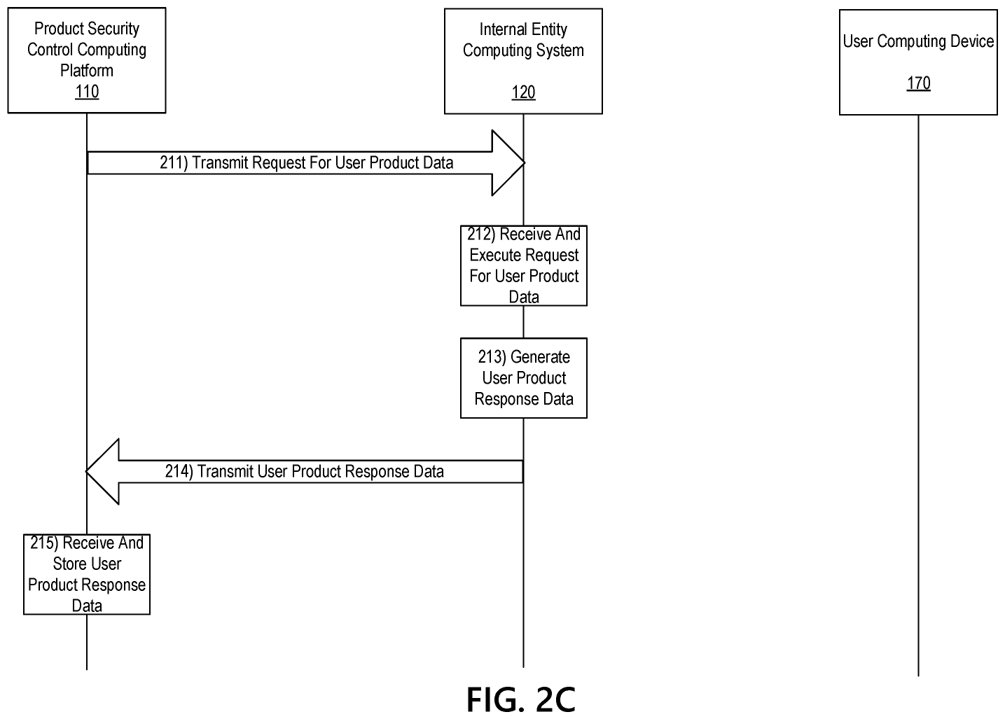

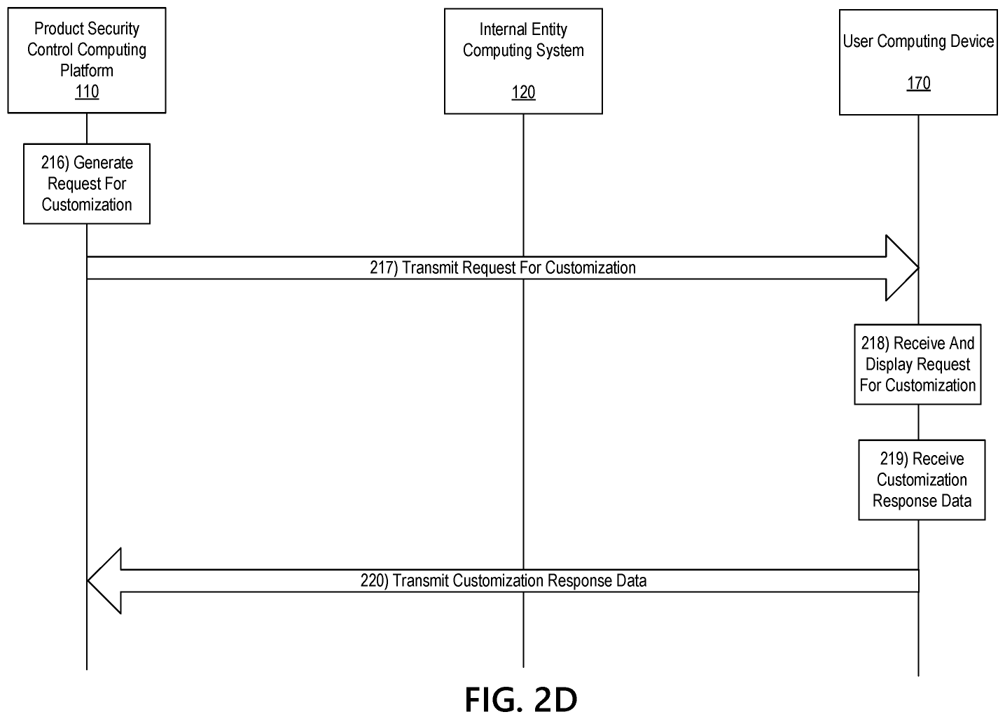

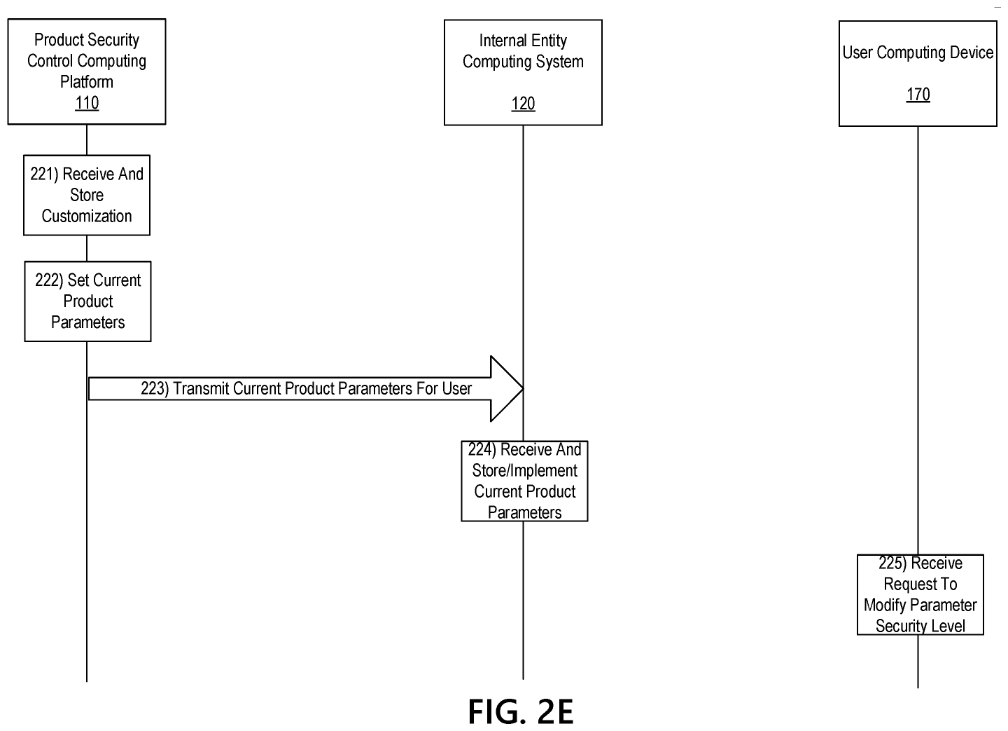

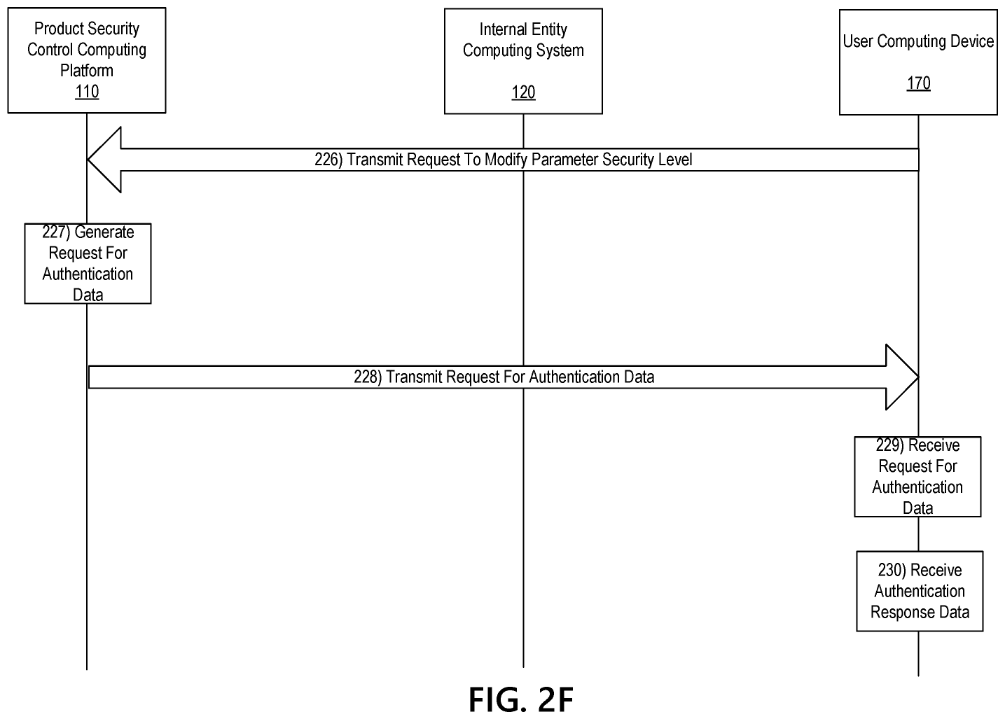

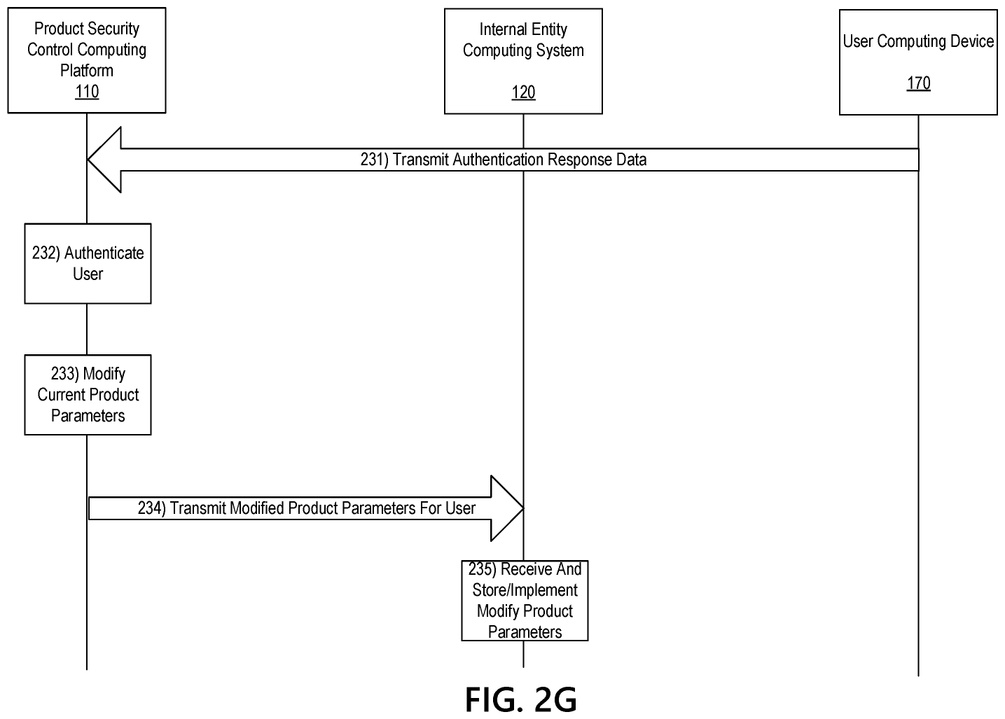

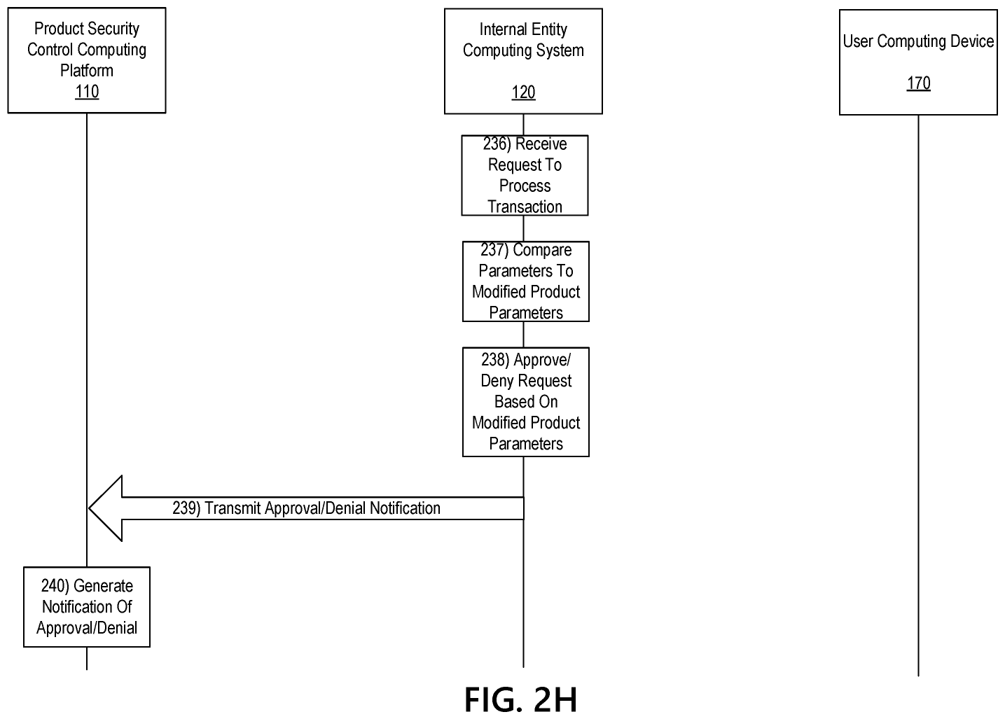

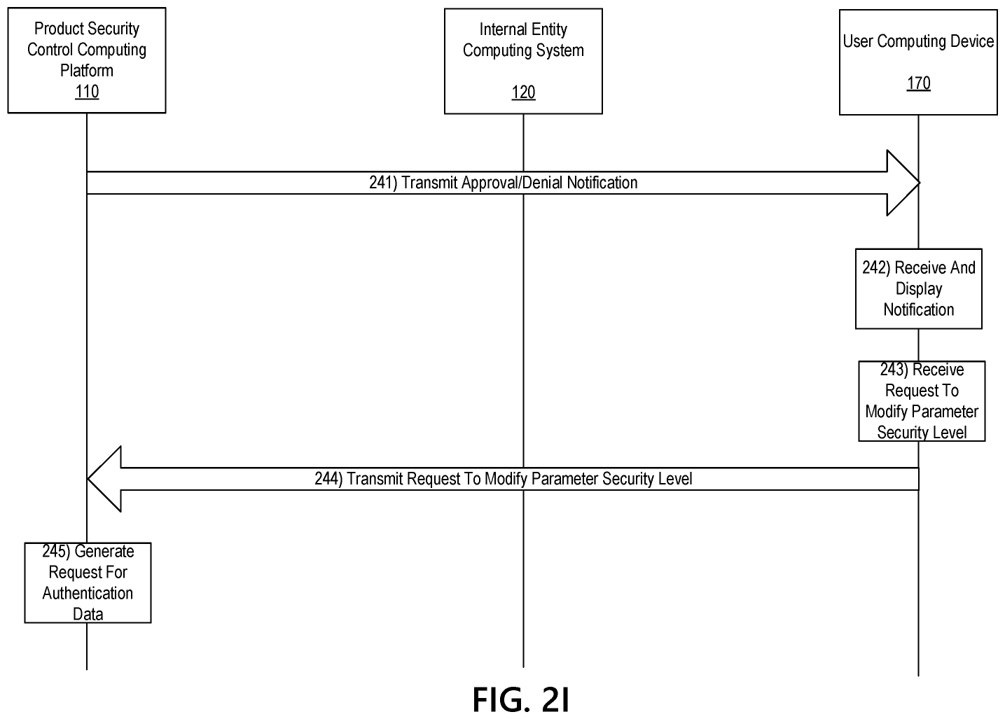

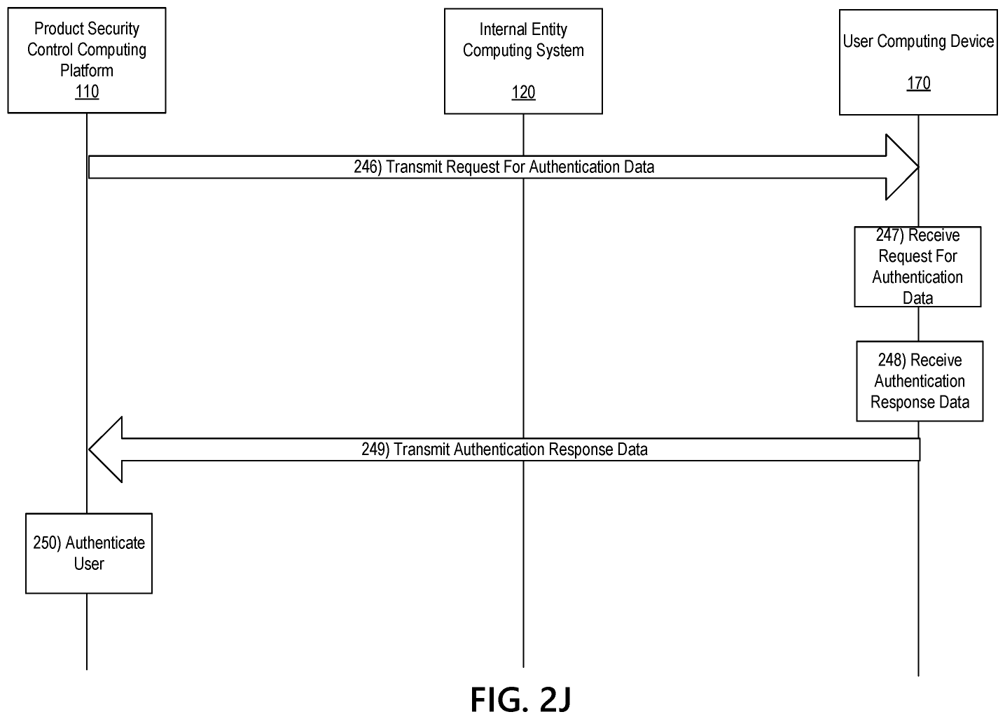

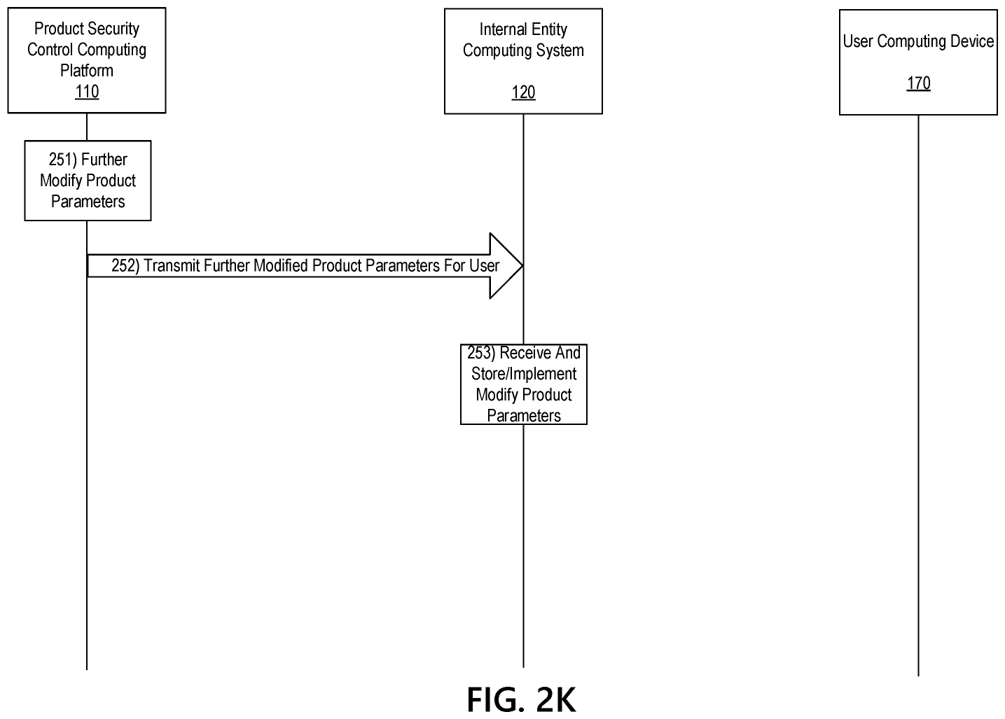

FIGS. 2A-2K depict one example illustrative event sequence for implementing product security control functions in accordance with one or more aspects described herein. The events shown in the illustrative event sequence are merely one example sequence and additional events may be added, or events may be omitted, without departing from the invention. Further, one or more processes discussed with respect to FIGS. 2A-2K may be performed in real-time or near real-time.

With reference to FIG. 2A, at step 201, product security control computing platform 110 may generate a user interface including an option to register and/or provide registration information to access ringfence functionality. In some examples, the interface may be generated in response to detecting a new user at an enterprise organization, a user not enrolled in ringfence functionality, or the like. Additionally or alternatively, the interface may be generated in response to a request from a user to opt-in to ringfence functionality.

At step 202, product security control computing platform 110 may connect to user computing device 170. For instance, a first wireless connection may be established between product security control computing platform 110 and user computing device 170. Upon establishing the first wireless connection, a communication session may be initiated between product security control computing platform 110 and user computing device 170.

At step 203, product security control computing platform 110 may transmit or send the user interface with the option to register and/or provide registration information to the user computing device 170. For instance, product security control computing platform 110 may transmit or send the user interface during the communication session initiated upon establishing the first wireless connection. In some examples, transmitting or sending may cause the user interface to be displayed by user computing device 170.

At step 204, user computing device 170 may receive and display the user interface. In response to displaying the user interface, user computing device 170 may receive user response data at step 205. For instance, the user response data may include acceptance of an option to register for ringfence functionality, registration information including name, unique identifier, contact information, and the like. In some examples, the user response data may include authentication credentials or data to be used when requesting a modified security level for ringfenced products. For instance, a username and password, PIN, biometrics, passphrase, or the like, may be provided in the user response data.

With reference to FIG. 2B, at step 206, user computing device 170 may transmit or send the user response data to the product security control computing platform 110. At step 207, product security control computing platform 110 may receive the user response data.

At step 208, product security control computing platform 110 may generate a user record including data provided in the user response data. For instance, a database may be modified to include an entry for the user requesting ringfence functionality, user registration details may be stored, authentication information may be stored, and the like.

At step 209, a request for user product data may be generated by the product security control computing platform 110. For instance, product security control computing platform 110 may generate a request for all products associated with the user (e.g., based on user name, user identifier, or the like). Products may include accounts (e.g., checking accounts, savings accounts, money market accounts, investment accounts, and the like), payment devices (e.g., debit cards, credit cards, or the like), retirement products or accounts (e.g., annuities, 401k, and the like) and/or other products provided by the enterprise organization.

At step 210, product security control computing platform 110 may connect to internal entity computing system 120. For instance, a second wireless connection may be established between product security control computing platform 110 and internal entity computing system 120. Upon establishing the second wireless connection, a communication session may be initiated between product security control computing platform 110 and internal entity computing system 120.

With reference to FIG. 2C, at step 211, product security control computing platform 110 may transmit or send the request for user product data to the internal entity computing system 120. For instance, the request for user product data may be sent during the communication session initiated upon establishing the second wireless connection.

Although the request for user product data is shown and described as being sent to internal entity computing system 120, the request for user product data may also be sent to internal entity computing system 125 and/or one or more other computing systems to retrieve all user product data.

At step 212, internal entity computing system 120 may receive and execute the request for user product data. For instance, the internal entity computing system 120 may query one or more databases or data storage systems using the user identifier as input to extract all user products associated with the user.

At step 213, user product response data may be generated by the internal entity computing system 120. For instance, the extracted user product data may be aggregated to generate user product response data.

At step 214, internal entity computing system 120 may transmit or send the user product response data to the product security control computing platform 110.

At step 215, product security control computing platform 110 may receive and store the user product response data. For instance, the one or more user products associated with the user or user identifier may be generated in the database record generated in response to receiving the user response data. Accordingly, the user record may be populated with user products.

With reference to FIG. 2D, at step 216, product security control computing platform 110 may generate a request for customization. For instance, product security control computing platform 110 may generate a user interface requesting user input to customize limits, restrictions, or the like, for one or more user products for each security level. In some examples, the user interface may include each user product received, a current or default limit (e.g., as determined by the enterprise organization), one or more options to modify a limit or restriction for each product and/or for each security level, and the like.

At step 217, product security control computing platform 110 may transmit or send the generated request for customization to the user computing device 170. In some examples, transmitting or sending the generated request for customization may cause the user computing device 170 to display the generated request for customization.

At step 218, user computing device 170 may receive and display the request for customization. For instance, user computing device 170 may receive and display the user interface providing customization options for the user for each product and/or security level.

At step 219, user computing device 170 may receive customization response data. For instance, a user may input (e.g., to the user interface and via a touchscreen, keypad, or the like) one or more limits or restrictions for one or more products and/or for one or more security levels. For instance, a user may identify customized limits and/or restrictions for one or more products for one or more of low, medium and/or high levels (e.g., first level, second level, third level). While three levels are described, more or fewer levels may be used without departing from the invention.

In some examples, the customization options may include selectable options that may be selected by a user (e.g., from a drop-down menu, or the like). Additionally or alternatively, the user interface may include interactive fields in which the user may input a desired limit for one or more security levels. For instance, a user may request a limit of $1000 for credit card purchases in a low security level, $500 for medium security level, and $100 for high security level. While many customization options may have various inputs (e.g., selectable inputs, user provided inputs), in some examples, a limit or restriction may be a binary option. For instance, funds transfers between accounts may be permitted at a low security level but prevented at medium and/or high security level. Various other examples of limits or restrictions may be used without departing from the invention.

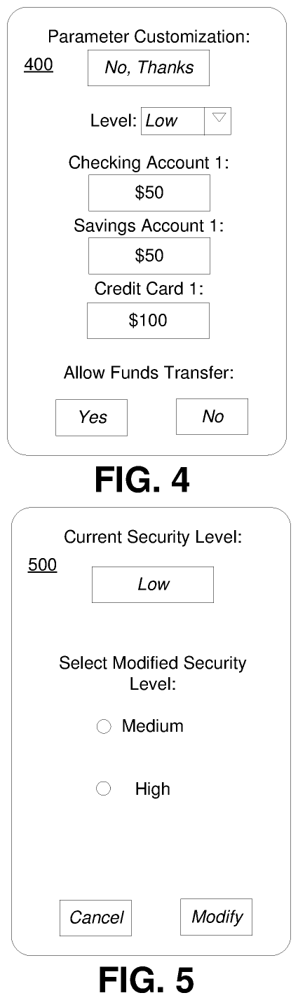

FIG. 4 illustrates one example user interface 400 that may be generated to request user input to customize limits and restrictions. As shown in FIG. 4, the interface 400 includes an option to decline customization (e.g., “No, Thanks”). If a user selects the option to decline customization, the enterprise organization may establish default limits and/or restrictions for each product for each security level. The interface 400 further includes an option to input customized limits or restrictions for the various security levels. As shown in FIG. 4, the inputs provided are for a “low” level of security. However, a user may select drop-down arrow to select “medium” or “high” or other levels of security to input restrictions or limits for products for all levels. As also shown in FIG. 4, various products are listed (e.g., Checking Account 1, Savings Account 1, Credit Card 1) and each has a corresponding field into which the user may enter a limit for that product for that security level. If any fields are blank, a default limit may be established by the enterprise organization. In some examples, restriction options may include binary options, such as a yes or no option to allow funds transfers at that level of security. The interface elements and arrangements shown in FIG. 4 are merely some example interface elements and arrangements. Various other elements and arrangements may be used without departing from the invention.

At step 220, user computing device 170 may transmit or send the user customization response data to the product security control computing platform 110.

With reference to FIG. 2E, at step 221, product security control computing platform 110 may receive and store to the customization response data. For instance, the user record may be modified to include the customized limits or restrictions selected or provided by the user in the customization response data. If the user has not selected a customized option for any product, a default limit or restriction may be identified by the enterprise organization and implemented.

At step 222, product security control computing platform 110 may set current product parameters for the ringfenced products of the user. For instance, based on a current security level (e.g., low) and customization options provided by the user and/or default options provided by the enterprise organization, current product parameters including limits or restrictions for each product may be identified.

At step 223, product security control computing platform 110 may transmit or send the current product parameters to the internal entity computing system 120. At step 224, internal entity computing system 120 may implement and/or store the current product parameters. Accordingly, when a user attempts a transaction using a product of the ringfenced products, internal entity computing system 120 may compare transaction parameters to the current product parameters to determine whether the transaction is within the current limit for that product. If so, the transaction may be approved. If not, the transaction may be denied.

At step 225, user computing device 170 may receive a request to modify a current security level. For instance, a user may be travelling performing another high risk activity in which heighted security may be desired. Accordingly, the user may request, e.g., via the application executing on the user computing device 170, to modify the current security level to a modified security level. FIG. 5 illustrates one example user interface 500 indicating a current security level (e.g., “low”) for the ringfenced products and providing options to modify the security level to one or more other security levels (e.g., “medium” or “high”). To modify the current security level, the user may select the radio button corresponding to the desired modified level. The arrangements shown in FIG. 5 are merely some example arrangements for a user interface to modify a security level. Various other arrangements may be used without departing from the invention.

With reference to FIG. 2F, at step 226, user computing device 170 may transmit or send the request to modify the security level to the product security control computing platform 110.

At step 227, product security control computing platform 110 may receive the request to modify the security level and, in response, may generate a request for authentication data. The request for authentication data may include a request for authentication to modify the security level of the ringfenced products which, in some examples, may be different from authentication data used to access the application through which the request to modify the security level was received.

At step 228, the product security control computing platform 110 may transmit or send the request for authentication data to user computing device 170. In some examples, transmitting or sending the request for authentication data may cause the request to be displayed by a display of the user computing device 170.

At step 229, user computing device 170 may receive and display the request for authentication data. In response, at step 230, authentication response data may be received by the user computing device 170. As discussed herein, the authentication response data may include a username and password, PIN, biometric data, or the like, provided during registration that may be different from the authentication data used to access the application executing on the user computing device 170.

With reference to FIG. 2G, step 231, user computing device 170 may transmit or send the authentication response data to the product security control computing platform 110. At step 232, product security control computing platform 110 may compare the authentication response data to prestored data received, for example, during the registration process, to determine whether the data matches. If so, the user may be authenticated and the process may continue. If not, the request to modify the security level may be denied and a notification may be transmitted to user computing device 170.

If the user is authenticated, at step 233, the security level may be modified and the current product parameters may be modified. For instance, one or more limits or restrictions on the ringfenced products may be modified to reflect the modified security level (e.g., a security level may be modified from low to high and, accordingly, limits or restrictions associated with each ringfenced product may be modified from low security parameters to corresponding high security parameters).

At step 234, the modified security level and modified parameters may be transmitted by the product security control computing platform 110 to the internal entity computing system 120. At step 235, the internal entity computing system may receive and store or implement the modified security level and associated modified parameters. For instance, one or more limits or restrictions for each ringfenced product of the user may be modified to replace the previous parameters with the modified parameters.

With reference to FIG. 2H, at step 236, internal entity may receive a request to process a transaction. For instance, a user may attempt a purchase using a ringfenced credit or debit card, a user may request a withdrawal from an automated teller machine (ATM), a user may request a funds transfer, or the like. In some examples, the request to process the transaction may be initiated by an actor at a computing system or device, such as a point-of-sale system at a vendor, ATM, or the like, and/or may be initiated via the enterprise organization application executing on the user computing device 170. Because any of these transactions may be initiated by an unauthorized user (e.g., via stolen payment device, stolen user computing device, or the like), the increased security level may provide additional protection and risk mitigation to the user.

At step 237, the internal entity computing system 120 may compare transaction parameters of the requested transaction to the modified parameters currently executed by the internal entity computing system 120 (e.g., the modified parameters associated with the modified security level).

Based on the comparing, at step 238, the internal entity computing system 120 may approve or deny the requested transaction. For instance, if the transaction parameters (e.g., amount, type, or the like) are within the modified parameters of the implemented security level, the transaction may be approved or authorized. If the transaction parameters are outside the modified parameters, the transaction may be denied. Accordingly, if an unauthorized actor is attempting the transaction, there may be a loss but the loss may be reduced greatly by the increased security limits.

At step 239, internal entity computing system 120 may transmit or send the transaction approval or denial to the product security control computing platform 110. At step 240, product security control computing platform 110 may generate a notification providing an indication of the approval or denial to the user.

With reference to FIG. 2I, at step 241, product security control computing platform 110 may transmit or send the approval/denial notification to user computing device 170. In some examples, transmitting or sending the approval/denial notification may cause the user computing device 170 to display the approval/denial notification.

At step 242, user computing device 170 may receive and display the approval/denial notification.

At step 243, user computing device 170 may receive another request to modify the security level of the ringfenced products. For instance, a user may have requested a heighted security level due to expected travel but now would like to return the security level to a lower level. Accordingly, the user may input the request to further modify the security level to the application executing on the user computing device 170.

At step 244, user computing device 170 may transmit or send the request to further modify the security level to the product security control computing platform 110.

At step 245, product security control computing platform 110 may receive the request to further modify the security level and, in response, may generate a request for authentication data. The request for authentication data may include a request for authentication to further modify the security level of the ringfenced products which, in some examples, may be different from authentication data used to access the application through which the request to modify the security level was received.

With reference to FIG. 2J, at step 246, the product security control computing platform 110 may transmit or send the request for authentication data to user computing device 170. In some examples, transmitting or sending the request for authentication data may cause the request to be displayed by a display of the user computing device 170.

At step 247, user computing device 170 may receive and display the request for authentication data. In response, at step 248, authentication response data may be received by the user computing device 170. As discussed herein, the authentication response data may include a username and password, PIN, biometric data, or the like, provided during registration that may be different from the authentication data used to access the application executing on the user computing device 170.

At step 249, user computing device 170 may transmit or send the authentication response data to the product security control computing platform 110. At step 250, product security control computing platform 110 may compare the authentication response data to prestored data received, for example, during the registration process, to determine whether the data matches. If so, the user may be authenticated and the process may continue. If not, the request to modify the security level may be denied and a notification may be transmitted to user computing device 170.

With reference to FIG. 2K, if the user is authenticated, at step 251, the security level may be further modified and the current product parameters may be further modified. For instance, one or more limits or restrictions on the ringfenced products may be further modified to reflect the modified security level (e.g., a security level may be modified from high to lower level and, accordingly, limits or restrictions associated with each ringfenced product may be modified from high security parameters to corresponding lower level security parameters (e.g., low level or medium level)).

At step 252, the further modified security level and further modified parameters may be transmitted by the product security control computing platform 110 to the internal entity computing system 120. At step 253, the internal entity computing system 120 may receive and store or implement the further modified security level and associated further modified parameters. For instance, one or more limits or restrictions for each ringfenced product of the user may be modified to replace the previous modified parameters with the further modified parameters. Accordingly, upon receiving a request to process a subsequent transaction, the transaction parameters may be compared to the further modified security level and parameters to determine whether the transaction is approved or denied.

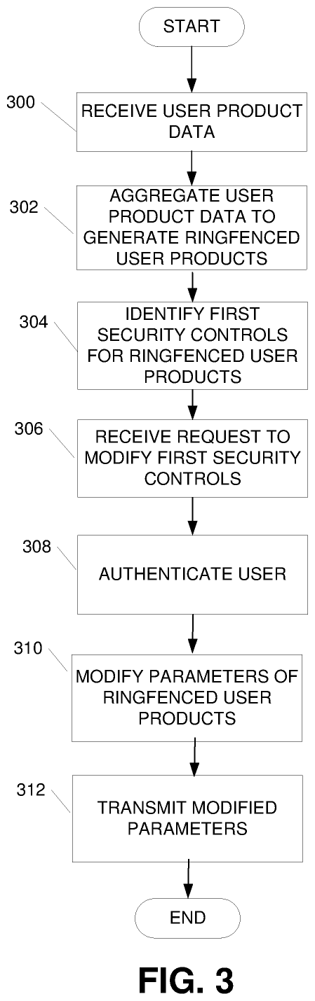

FIG. 3 is a flow chart illustrating one example method of implementing product security controls in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, product security control computing platform 110 may receive user product data. In some examples, the data may be received from a user (e.g., during a registration process) or may be retrieved from one or more systems or devices associated with the enterprise organization (e.g., internal entity computing system 120, 125). The user product data may include a plurality of user products, such as accounts, payment devices, and the like associated with or provided by an enterprise organization.

At step 302, product security control computing platform 110 may aggregate the received user product data to generate ringfenced user products. The products within the ringfenced user products may be subject to security controls that may be modified by a user. In some examples, modification of a security level associated with the security controls may modify one or more limits or restrictions associated with each product of the ringfenced user products. In some arrangements, the limits or restrictions may be received from the user via a customization process.

At step 304, first security controls associated with the ringfenced user products may be identified. For instance, first security controls may be identified and a first security level associated with the first security controls may be identified.

At step 306, product security control computing platform 110 may receive a request to modify the first security controls associated with the ringfenced user products from the first security level to a second security level. In some examples, the request to modify the first security controls may be received via an application executing on a user computing device and associated with the enterprise organization, such as a mobile banking application.

At step 308, product security control computing platform 110 may authenticate the user in response to the request to modify the first security controls. In some examples, authentication of the user may be performed via the application executing on the user computing device 170 but may require different authentication credentials than authentication credentials used to authenticate the user to the application (e.g., an additional authentication step may be performed to access the modification functions and may require different authentication credentials than those used to access the application).

At step 310, in response to authenticating the user, product security control computing platform 110 may modify parameters of the ringfenced user products. For instance, parameters such as transaction limits, ability to transfer funds, and the like, may be modified from first parameters associated with the first security level to second parameters associated with the second security level.

At step 312, product security control computing platform 110 may transmit the second parameters to a transaction processing computing system, such as internal entity computing system 120, internal entity computing system 125, or the like for storage and/or implementation. In some examples, transmitting the second parameters may include transmitting the second parameters to an application programming interface (API) gateway to ensure transaction are processed within the limits. For instance, transmitting the second parameters may cause the transaction processing computing system to modify security controls of the ringfenced user products based on the second parameters and implement the second parameters in transaction decisioning (e.g., in determining whether parameters of a requested transaction are within the limits or parameters currently in place).

Accordingly, aspects described herein reduce risk associated with unauthorized access to user accounts, payment devices, and the like, by controlling, in a single step, security controls associated with all ringfenced user products or channels. For instance, a user may select to modify a security level associated with ringfenced products at time when risk of unauthorized access may be increased (e.g., in crowded areas, when travelling, or the like). Further, by modifying security controls for all ringfenced products through one step or action, the risk of loss may be greatly reduced.

For instance, in one example, a user may typically have a first level of security controls associated with all ringfenced products. In this first level, the user may have a $500 limit on withdrawals from a checking account and a savings account, and may have a $1000 limit on credit card purchases. In addition, the user may, at the first security level, allow funds transfers from one or more accounts of the user to one or more other accounts (e.g., one or more other accounts of the user or one or more accounts of other users). If the user is going to be traveling for the next week and would like increased security to reduce risk associated with unauthorized access, the user may modify the security level of the ringfenced products to lower transaction limits, deny funds transfers, or the like, in order to reduce risk of loss should an unauthorized user gain access to one or more ringfenced user products.

Accordingly, in this example, the user may access a mobile banking application executing on the user computing device. Accessing the mobile banking application may require the user to provide first authentication credentials. Upon being authenticated to the mobile banking application, the user may request to modify the first level of security controls to a second level of security controls. Upon requesting the modification, the mobile banking application may display a request for second authentication credentials, different from the first authentication credentials. By requiring different authentication credentials to modify security levels, the system may prevent unauthorized users who may have access to the mobile user device to change the security level or increase transaction limits.

Accordingly, the security level for ringfenced products may be set for expected risk in a current location or expected location. In some examples, the security level may be set for a predetermined time period. Upon expiration of the time period, the security level may revert to a previous level. Thus, users can plan for increased risk situations.

If the user is authenticated, the first security level may be modified to a second security level. Accordingly, at the second security level, the user may have a $100 limit on withdrawals from a checking account and a savings account, and may have a $250 limit on credit card purchases. Accordingly, should an unauthorized user gain access to a credit card or account of the user, the potential total loss may be greatly reduced by implementing lower transaction limits. Further, by changing the limits for all ringfenced products in a single step, the risk of loss is greatly reduced. The user may then further modify the security level for even greater security as needed, or may return to the lower level of security as desired (e.g., when the trip is completed and risk is again at a standard level).

Although aspects described herein are discussed as finite limits being provided, in some examples, the limits or parameters may be relative to a default or first security level setting. For instance, a credit card may have a default limit at a first security level. At the second security level, the limit may be reduced by a certain percent (e.g., reduced by 25%, 30% or the like) of the default limit. At a third security level, the limit may be further reduced by a certain percent of the second security level limit (e.g., reduced another 10%, 15%, or the like) or may be reduced relative to the default limit (e.g., reduced 50% of default limit at first security level, 60% of default limit at first security level, or the like). Although these relative changes are described in the context of a credit card limit, similar modifications relative to a default or first security level limit may be used with ATM withdrawals, checking or savings account withdrawals, debit card purchases, or the like.

In some examples, restrictions may be used to disable certain types of authentication data to conduct transactions. For instance, in some security levels, a user may request to disable biometric data, PIN as authenticator, or the like. In some examples, restrictions may require that a physical card be present to make a purchase, that a user provide a signature, or the like. Various other restrictions may be used without departing from the invention.

Further, as discussed herein, in some examples, the security control level may be modified by a user request received via a telephone channel (e.g., a user may call for customer assistance). In these arrangements, the user may have a pre-stored passphrase or passcode that may be provided to the customer service associate to authenticate the user and modify the security controls. In some examples, should a user need to reset security controls, change authentication credentials for modifying security controls, or the like, the user may similarly provide the passphrase or passcode to the customer service associate.

The arrangements described herein may also dynamically update or modify as new products are obtained or identified for the user. For instance, if a user opens a second checking account with the enterprise organization, the computing platform may receive that information and automatically add the second checking account to the ringfenced user products. The user may then be prompted to customize limits for the second checking account, if desired.

Further, the arrangements described herein may enable limits or restrictions that are not currently available to users. For instance, for some types of accounts, a user might not have the ability to limit wire transfers, withdrawals, or the like. The ringfencing functions provided herein enable limits to be placed on those types of funds or events, in a single action, to further increase user product security, which are functions that may not be currently available.

While aspects described herein are discussed in the context of reducing risk for a user, aspects described may also be used to protect vulnerable populations. For instance, a caregiver may set a security level for ringfenced user products for a vulnerable user. Accordingly, the vulnerable user may still independently conduct transactions within the limit, thereby protecting the vulnerable user from potential excess spending.

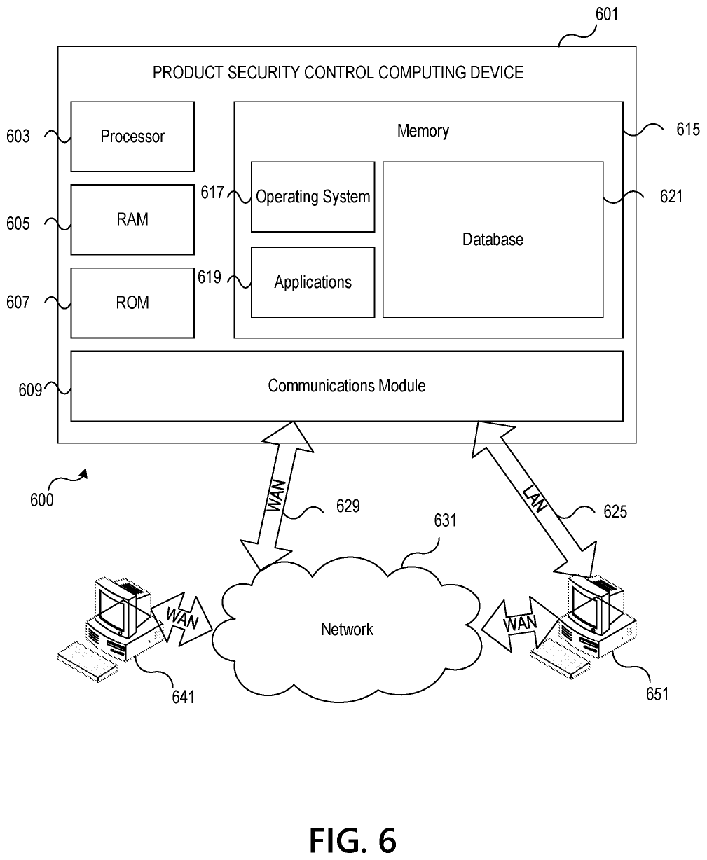

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include product security control computing device 601 having processor 603 for controlling overall operation of product security control computing device 601 and its associated components, including Random Access Memory (RAM) 605, Read-Only Memory (ROM) 607, communications module 609, and memory 615. Product security control computing device 601 may include a variety of computer readable media. Computer readable media may be any available media that may be accessed by data control computing device 801, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by product security control computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on product security control computing device 601. Such a processor may execute computer-executable instructions stored on a computer-readable medium.

Software may be stored within memory 615 and/or storage to provide instructions to processor 603 for enabling product security control computing device 601 to perform various functions as discussed herein. For example, memory 615 may store software used by product security control computing device 601, such as operating system 617, application programs 619, and associated database 621. Also, some or all of the computer executable instructions for product security control computing device 601 may be embodied in hardware or firmware. Although not shown, RAM 605 may include one or more applications representing the application data stored in RAM 605 while product security control computing device 601 is on and corresponding software applications (e.g., software tasks) are running on product security control computing device 601.

Communications module 609 may include a microphone, keypad, touch screen, and/or stylus through which a user of product security control computing device 601 may provide input, and may also include one or more of a speaker for providing audio output and a video display device for providing textual, audiovisual and/or graphical output. Computing system environment 600 may also include optical scanners (not shown).

Product security control computing device 601 may operate in a networked environment supporting connections to one or more remote computing devices, such as computing device 641 and 651. Computing devices 641 and 651 may be personal computing devices or servers that include any or all of the elements described above relative to product security control computing device 601.

The network connections depicted in FIG. 6 may include Local Area Network (LAN) 625 and Wide Area Network (WAN) 629, as well as other networks. When used in a LAN networking environment, product security control computing device 601 may be connected to LAN 625 through a network interface or adapter in communications module 609. When used in a WAN networking environment, product security control computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive user product data, wherein the user product data includes one or more accounts and one or more payment devices associated with a user;
aggregate the user product data including the one or more accounts and payment devices of the user, wherein aggregating the user product data generates ringfenced user products;
identify first security controls associated with the ringfenced user products, wherein the first security controls include a first security level;
receive, from a user computing device and via an application executing on the user computing device, a request to modify the first security controls associated with the ringfenced user products from the first security level to a second security level;
authenticate the user;
responsive to authenticating the user, modify parameters of the ringfenced user products from first parameters associated with the first security level to second parameters associated with the second security level; and
transmit the second parameters to a transaction processing computing system, wherein transmitting the second parameters to the transaction processing computing system causes the transaction processing computing system to modify security controls of the ringfenced user products based on the second parameters and implement the second parameters in transaction decisioning.

2. The computing platform of claim 1, further including instructions that, when executed, cause the computing platform to:
receive, from the user computing device, user customization selections, wherein the user customization selections identify one or more limits or restrictions for each product of the ringfenced user products for the first security level and the second security level,
wherein the first parameters and the second parameters are based on the received user customization selections.

3. The computing platform of claim 1, wherein modifying parameters of the ringfenced user products including modifying parameters of each product of the ringfenced user products.

4. The computing platform of claim 1, wherein modifying the parameters of the ringfenced user products includes modifying a transaction limit for each payment device of the one or more payment devices and each account of the one or more accounts.

5. The computing platform of claim 1, wherein modifying the parameters of the ringfenced user products includes preventing funds transfers for the one or more accounts.

6. The computing platform of claim 1, wherein authenticating the user includes receiving authentication credentials for modifying a security level associated with the user and comparing the authentication credentials for modifying the security level to pre-stored authentication credentials for modifying the security level.

7. The computing platform of claim 6, wherein the authentication credentials for modifying the security level are different from authentication credentials used to access the application executing on the user computing device.

8. A method, comprising:
receiving, by a computing platform, the computing platform having at least one processor and memory, user product data, wherein the user product data includes one or more accounts and one or more payment devices associated with a user;
aggregating, by the at least one processor, the user product data including the one or more accounts and payment devices of the user, wherein aggregating the user product data generates ringfenced user products;
identifying, by the at least one processor, first security controls associated with the ringfenced user products, wherein the first security controls include a first security level;
receiving, by the at least one processor and from a user computing device via an application executing on the user computing device, a request to modify the first security controls associated with the ringfenced user products from the first security level to a second security level;
authenticating, by the at least one processor, the user;
responsive to authenticating the user, modifying, by the at least one processor, parameters of the ringfenced user products from first parameters associated with the first security level to second parameters associated with the second security level; and
transmitting, by the at least one processor, the second parameters to a transaction processing computing system, wherein transmitting the second parameters to the transaction processing computing system causes the transaction processing computing system to modify security controls of the ringfenced user products based on the second parameters and implement the second parameters in transaction decisioning.

9. The method of claim 8, further including:
receiving, by the at least one processor and from the user computing device, user customization selections, wherein the user customization selections identify one or more limits or restrictions for each product of the ringfenced user products for the first security level and the second security level,
wherein the first parameters and the second parameters are based on the received user customization selections.

10. The method of claim 8, wherein modifying parameters of the ringfenced user products including modifying parameters of each product of the ringfenced user products.

11. The method of claim 8, wherein modifying the parameters of the ringfenced user products includes modifying a transaction limit for each payment device of the one or more payment devices and each account of the one or more accounts.

12. The method of claim 8, wherein modifying the parameters of the ringfenced user products includes preventing funds transfers for the one or more accounts.

13. The method of claim 8, wherein authenticating the user includes receiving authentication credentials for modifying a security level associated with the user and comparing the authentication credentials for modifying the security level to pre-stored authentication credentials for modifying the security level.

14. The method of claim 13, wherein the authentication credentials for modifying the security level are different from authentication credentials used to access the application executing on the user computing device.

15. One or more non-transitory computer-readable media storing instructions that, when executed by a computing platform comprising at least one processor, memory, and a communication interface, cause the computing platform to:
receive user product data, wherein the user product data includes one or more accounts and one or more payment devices associated with a user;
aggregate the user product data including the one or more accounts and payment devices of the user, wherein aggregating the user product data generates ringfenced user products;
identify first security controls associated with the ringfenced user products, wherein the first security controls include a first security level;
receive, from a user computing device and via an application executing on the user computing device, a request to modify the first security controls associated with the ringfenced user products from the first security level to a second security level;
authenticate the user;
responsive to authenticating the user, modify parameters of the ringfenced user products from first parameters associated with the first security level to second parameters associated with the second security level; and
transmit the second parameters to a transaction processing computing system, wherein transmitting the second parameters to the transaction processing computing system causes the transaction processing computing system to modify security controls of the ringfenced user products based on the second parameters and implement the second parameters in transaction decisioning.

16. The one or more non-transitory computer-readable media of claim 15, further including instructions that, when executed, cause the computing platform to:
receive, from the user computing device, user customization selections, wherein the user customization selections identify one or more limits or restrictions for each product of the ringfenced user products for the first security level and the second security level,
wherein the first parameters and the second parameters are based on the received user customization selections.

17. The one or more non-transitory computer-readable media of claim 15, wherein modifying parameters of the ringfenced user products including modifying parameters of each product of the ringfenced user products.

18. The one or more non-transitory computer-readable media of claim 15, wherein modifying the parameters of the ringfenced user products includes modifying a transaction limit for each payment device of the one or more payment devices and each account of the one or more accounts.

19. The one or more non-transitory computer-readable media of claim 15, wherein modifying the parameters of the ringfenced user products includes preventing funds transfers for the one or more accounts.

20. The one or more non-transitory computer-readable media of claim 15, wherein authenticating the user includes receiving authentication credentials for modifying a security level associated with the user and comparing the authentication credentials for modifying the security level to pre-stored authentication credentials for modifying the security level.

21. The one or more non-transitory computer-readable media of claim 20, wherein the authentication credentials for modifying the security level are different from authentication credentials used to access the application executing on the user computing device.
